(19) United States
(12) Patent Application Publication
(10) Pub. No.: US 2018/0281100 A1
(43) Pub. Date: Oct. 4, 2018

(54) PLASMA WELDING METHOD

(71) Applicant: TAIYO NIPPON SANSO CORPORATION, Shinagawa-ku (JP)

(72) Inventor: Katsunori WADA, Kai-shi (JP)

(21) Appl. No.: 15/754,638

(22) PCT Filed: Sep. 27, 2016
(86) PCT No.: PCT/JP2016/078495

§ 371 Date: Feb. 23, 2018

(30) Foreign Application Priority Data
Sep. 29, 2015 (JP) 2015-191457

(51) Int. Cl. B23K 10/02; H05H 1/36

(52) U.S. Cl. CPC B23K 10/02; H05H 2001/3426; H05H 1/36

(57) ABSTRACT

One object of the present invention is to provide a plasma welding method capable of performing plasma welding while restraining initial investment in a welding device, and the present invention provide a plasma welding method includes a pilot arc generation step in which a pilot arc is generated between the electrode and the insert chip by supplying a first pilot gas which is easily converted into a plasma state between the electrode and the insert chip while supplying a shield gas between the insert chip and the shield cap; and a first welding step in which, after the pilot arc generation step, a main arc is generated between the electrode and the workpiece by electrically disconnecting the plus terminal and the insert chip by the first selector switch while supplying the first pilot gas and the shield gas.

### TECHNICAL FIELD

The present invention relates to a plasma welding method.

### BACKGROUND ART

Conventionally, a TIG welding method or a plasma welding method is used as a non-consumable electrode type welding method for welding a workpiece (base material). Since the plasma welding method is superior to a TIG welding method in heat convergence, the plasma welding method is a welding method with a narrow bead width, a welding at high speed, and less distortion.

The plasma welding method includes a plasma arc method (transfer type plasma), a plasma jet method (non-transfer type plasma), and the like.

Generally, a welding device of the plasma arc type (a plasma arc type welding device) includes a torch, a main electric power source having a minus terminal connected to an electrode constituting the torch, and a plus terminal electrically connected to the workpiece, a pilot arc electric power source electrically connected to the main electric power source via a wire, a selector switch provided on a wire connecting the pilot arc electric power source and an insert chip (also referred to as a “constraint nozzle”) constituting the torch, and a high frequency device for generating a pilot arc.

In the case of using the plasma arc type plasma welding device, it is possible to perform welding with a comparatively large penetration.

In the case of using a welding device of the plasma jet type (a plasma jet type plasma welding device), a minus terminal of a main power source is connected to an electrode constituting a torch, and a plus terminal of the main power source is connected to an insert chip constituting the torch.

In the plasma jet method, since current does not flow in the workpiece to be welded, the plasma jet method is also used as a heat source of thermal spraying and a heat source of a furnace.

A composite type plasma welding device disclosed in Patent Document 1 includes a torch and an electric power source (hereinafter referred to as “composite type plasma electric power source”). The composite type plasma electric power source includes a main arc electric power source (also referred to as “main electric power source”), a pilot arc electric power source, and a high-frequency device.

In the main arc electric power source (main electric power source), a minus terminal is connected to an electrode constituting a torch, and a plus terminal is electrically connected to a workpiece. The pilot arc electric power source is electrically connected to the main arc electric power source and an insert chip.

The composite type plasma welding device constructed as described above can produce stable plasma even at very low current, so that it is possible to weld an extremely thin plate which is difficult with the TIG welding method.

### PRIOR ART DOCUMENTS

### Patent Literature

Patent Document 1 Japanese Unexamined Patent Application, First Publication No. S63-194867

### SUMMARY OF INVENTION

### Problem to be Solved by the Invention

Incidentally, as an electric power source (hereinafter referred to as “TIG electric power source”) constituting a TIG welding device, a welding electric power source and a high-frequency device are used. The TIG electric power source has a very simple structure.

Thus, compared with the TIG electric power source, since the plasma electric power source is expensive, it is a factor of increasing the cost of the plasma welding device.

For this reason, despite the good welding performance of the plasma welding device, there is a problem that it is difficult to adopt a plasma welding device which can obtain deep penetration due to the disadvantage that the cost at the time of initial investment is high.

It is conceivable to perform plasma welding using the inexpensive TIG electric power source instead of the plasma electric power source.

However, the no-load voltage of the TIG electric power source is about a fraction of the no-load voltage of the plasma electric power source. Therefore, there was a problem that plasma welding cannot be performed merely by using the inexpensive TIG electric power source instead of the plasma electric power source.

It is therefore an object of the present invention to provide a plasma welding method capable of performing plasma welding while restraining initial investment in a welding device.

### Means for Solving the Problem

In order to solve the problems, the present invention provides the following plasma welding methods.

(1) A plasma welding method using a welding device including one welding electric power source for a TIG welding device; a welding torch including an electrode extending in a predetermined direction, an insert tip surrounding the electrode, and a shield cap surrounding the outside of the insert tip; and a first selector switch which is configured to electrically connect or disconnect a plus terminal of the welding electric power source and the insert chip,

wherein the plasma welding method includes:

a pilot arc generation step in which a pilot arc is generated between the electrode and the insert chip by electrically connecting the plus terminal and the insert chip by the first selector switch, supplying a first pilot gas which is easily converted into a plasma state between the electrode and the insert chip while supplying a shield gas between the insert chip and the shield cap; and

a first welding step in which, after the pilot arc generation step, a main arc is generated to weld the workpiece between the electrode and the workpiece by electrically disconnecting the plus terminal and the insert chip by the first selector switch while supplying the first pilot gas and the shield gas.

(2) The plasma welding method according to (1), wherein the plasma welding method includes a second welding step, instead of the first welding step; and

in the second welding step, after the pilot arc generation step, the main arc is generated to weld the workpiece between the electrode and the workpiece by electrically disconnecting between the plus terminal and the insert chip by the first selector switch, then electrically connecting the plus terminal and the workpiece, stopping the supply of the first pilot gas, while supplying the shield gas, and supplying a second pilot gas which is more suitable for plasma welding than the first pilot gas between the electrode and the insert chip.

(3) The plasma welding method according to (2),

wherein the plasma welding device further includes a second selector switch which is configured to electrically connect or disconnect between the plus terminal and the workpiece, and

in the second welding step, while the plus terminal and the insert chip are electrically connected with each other by the first selector switch, the plus terminal and the workpiece are electrically connected with each other by the second selector switch, and then the plus terminal and the insert chip are instantaneously electrically disconnected by the first selector switch.

(4) The plasma welding method according to (1),

wherein the welding device further includes a wire which is configured to always electrically connect between the plus terminal and the workpiece, and

the plasma welding method includes a third welding step instead of the first welding step, and

the third welding step includes:

a first stage in which, after the pilot arc generation step, the main arc is generated between the electrode and the workpiece by electrically disconnecting the plus terminal and the insert chip by the first selector switch, stopping the supply of the first pilot gas while supplying the shield gas, and supplying a second pilot gas which is more suitable for plasma welding than the first pilot gas between the electrode and the insert chip at a first flow rate; and

a second stage in which while supplying the shield gas, the second pilot gas is supplied at a second flow rate lower than the first flow rate at the end of the third welding step.

(5) The plasma welding method according to (4),

wherein the plasma welding device includes another wire in which a second selector switch configured to electrically connect or disconnect between the plus terminal and the workpiece is provided, instead of the wire, and

in the third welding step, while the plus terminal and the insert chip are electrically connected with each other by the first selector switch, the plus terminal and the workpiece are electrically connected with each other by the second selector switch, and then the plus terminal and the insert chip are instantaneously electrically disconnected by the first selector switch.

(6) The plasma welding method according to any one of (1) to (5), wherein any one selected from the group consisting of argon gas, a mixed gas of argon and hydrogen, a mixed gas of argon and helium, and a mixed gas of argon and nitrogen is used as the first pilot gas.
(7) The plasma welding method according to any one of (2) to (6), wherein a gas which has a higher potential gradient ratio than that of the first pilot gas, and is selected from a mixed gas of argon and hydrogen, a mixed gas of argon and helium, a mixed gas of argon and nitrogen, a mixed gas of argon, helium and hydrogen, a mixed gas of argon, helium, and nitrogen is as the second pilot gas.
(8) The plasma welding method according to any one of (1) to (7), wherein a no-load voltage of a TIG welding electric power source is used to generate the main arc.
(9) The plasma welding method according to any one of (1) to (7), wherein a high-frequency voltage generating device of a TIG welding electric power source is used to generate the main arc.
(10) The plasma welding method according to any one of (1) to (7), wherein the welding device further includes a shield gas supply line which is connected to a shield gas supply source and supplies the shield gas to the welding torch, a pilot gas supply line which is connected to a pilot gas supply source and supplies the pilot gas to the welding torch, and a solenoid valve and a check valve are provided in the shielding gas supply line and/or the pilot gas supply line in this order in a direction from the upstream side to the downstream side.

### Effects of the Invention

According to the present invention, it is possible to perform plasma welding while restraining the initial investment in the welding device.

### BRIEF DESCRIPTION OF DRAWINGS

FIG. 1 is a schematic diagram showing a structure of an example of a welding device used in carrying out a plasma welding method according to a first embodiment of the present invention.

FIG. 2 is a view showing a timing chart for explaining a plasma welding method according to the first embodiment using the welding device shown in FIG. 1.

FIG. 3 is a schematic diagram showing a structure of an example of a welding device used for carrying out a plasma welding method according to a second embodiment of the present invention.

FIG. 4 is a view showing a timing chart for explaining a plasma welding method according to a second embodiment using the welding device shown in FIG. 3.

FIG. 5 is a schematic diagram showing a structure of an example of a welding device used for carrying out a plasma welding method according to a third embodiment of the present invention.

FIG. 6 is a timing chart for explaining a plasma welding method according to a third embodiment using the welding device shown in FIG. 5.

### DETAILED DESCRIPTION OF THE PREFERRED EMBODIMENTS

Hereinafter, embodiments to which the present invention is applied will be described in detail with reference to the drawings. The drawings used in the following description are for showing the structure of the embodiment of the present invention, and the sizes, thicknesses, dimensions, and so on of the respective parts shown are different from the actual dimensional relationship of the welding device.

### First Embodiment

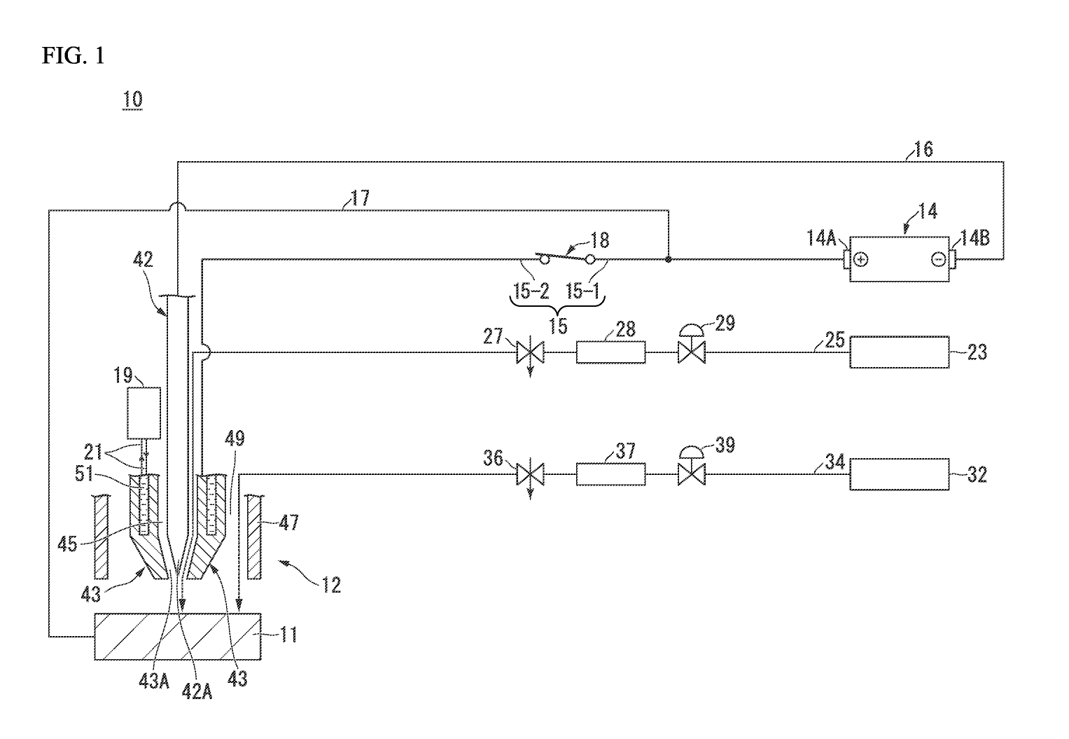

FIG. 1 is a schematic diagram showing a structure of an example of a welding device used for carrying out a plasma welding method according to a first embodiment of the present invention.

In FIG. 1, for convenience of explanation, an insert chip 43 and a shield cap 47 which constitute a welding torch 12, and a workpiece 11 are shown in cross section. Further, in FIG. 1, the components other than the components of the welding device 10 are shown by dotted lines. In addition, FIG. 1 schematically shows a state in which a first selector switch 18 is closed.

As shown in FIG. 1, the welding device 10 of the first embodiment includes a welding torch 12, a welding electric power source 14, wires 15 to 17, a first selector switch 18, a cooling water circulation section 19, a circulation line 21, a first pilot gas supply source 23, a first pilot gas supply line 25, needle valves 27 and 36, flow meters 28 and 37, solenoid valves 29 and 39, a shield gas supply source 32, a shield gas supply line 34, and a control unit (not shown).

The welding torch 12 is a torch for plasma welding and includes a torch switch (not shown), an electrode 42, an insert chip 43, a pilot gas supply passage 45, a shield cap 47, and a shield gas supply passage 49.

The torch switch (not shown) is turned on during the period in which the pilot arc is generated and during a last period in a first welding step described below (specifically, during the period in which the current value of the main arc decreases from the predetermined current value).

Then, the torch switch is turned off during the welding step other than the last period of the welding step.

The electrode 42 is a non-consumable electrode extending in one direction and has a chip portion 42 A having a pointed shape. The chip portion 42A is completely accommodated in the insert chip 43. The electrode 42 is made of a metal material having a high melting point.

As a material of the electrode 42, for example, tungsten, or a material obtained by adding an oxide (for example, thorium oxide, lanthanum oxide, cerium oxide, yttrium oxide, zirconium oxide or the like) to tungsten can be used.

The insert chip 43 is a tubular member arranged so as to surround the outer periphery of the electrode 42 so that a gap is interposed between the insert chip 43 and the electrode 42 (in other words, so that the pilot gas supply passage 45 can be formed). The central axis of the insert chip 43 coincides with the central axis of the electrode 42 (central axis extending in the extending direction of the electrode 42).

The insert chip 43 has a cooling water flow passage 51 capable of supplying cooling water into the inside thereof.

Cooling water for cooling the insert chip 43 is supplied to the cooling water flow passage 51. The chip portion of the insert chip 43 has a shape that is reduced in diameter with respect to the direction from the base end to the chip end of the insert chip 43.

The chip of the insert chip 43 has an insert chip hole 43 A that ejects a plasma arc generated from the electrode 42 to the outside of the insert chip 43.

Since the plasma arc generated at the electrode 42 receives the wall effect and the thermal pinch effect by the insert chip 43, the plasma arc is throttled and becomes an arc with a high energy density and is ejected from the insert chip hole 43A.

The pilot gas supply passage 45 is a substantially tubular space partitioned by the outer surface of the electrode 42 and the inner surface of the insert chip 43. The pilot gas supply passage 45 is connected to the first pilot gas supply source 23 via the first pilot gas supply line 25.

When the pilot gas is supplied from the first pilot gas supply source 23 to the pilot gas supply passage 45, the pilot gas is supplied to the chip 42A of the electrode 42.

The shield cap 47 has a tubular shape (cylindrical shape) arranged so as to surround the outer periphery of the insert chip 43 so that a gap is interposed between the shield cap 47 and the insert chip 43 (in other words, so that the shield gas supply passage 49 can be formed). The central axis of the shield cap 47 coincides with the central axis of the electrode 42.

The shape of the distal end portion of the shield cap 47 is formed into a reduced diameter shape.

The shield gas supply passage 49 is a substantially tubular space partitioned by the outer surface of the insert chip 43 and the inner surface of the shield cap 47. The shield gas supply passage 49 is connected to the shield gas supply source 32 via the shield gas supply line 34.

When the shield gas is supplied from the shield gas supply source 32 to the shield gas supply passage 49, the shield gas is supplied to the chip side of the welding torch 12.

The welding electric power source 14 is one welding electric power source used in the TIG welding device, and includes a high frequency device or a high voltage device.

The first welding electric power source 14 is an inexpensive welding electric power source used in a general TIG welding device, not a general conventional plasma electric power source (specifically, an electric power source including a plasma arc electric power source, a pilot arc electric power source, and a high frequency device).

As the first welding electric power source 14, for example, a high frequency device for arc formation, a high voltage device for arc formation, or a welding electric power source which can adjust the DC output current, initial current, crater current, gas pre-flow processing time, gas after-flow processing time, current up slope time, current down slope time, pulse frequency, pulse width, and so on can be used.

Specifications of the first welding electric power source 14 include, for example, a direct current output current in a range from 2 A to 500 A, an initial current in a range from 2 A to 500 A, a crater current in a range from 2 A to 500 A, a gas pre-flow processing time in a range from 0 second to 30 seconds, a gas after-flow processing time in a range from 0 second to 30 seconds, a upslope time in a range from 0 second to 10 seconds, a current output in a range from 0 second to 10 seconds, a downslope time in a range from 0 second to 10 seconds, a current output in a range from 0 second to 10 seconds, a pulse frequency in a range from 0.1 Hz to 999 Hz, and a pulse width in a range from 5% to 95%.

As the first welding electric power source 14, for example, an AC/DC welding electric power source, which can use both alternating current and direct current, can also be used. In this case, only the direct current function of the AC/DC welding electric power source is used.

The first welding electric power source 14 has a plus terminal 14A and a minus terminal 14B. The plus terminal 14A is connected to one end of the first wire 15-1 constituting the wire 15. When the first selector switch 18 is on (closed), the plus terminal 14A is electrically connected to the insert chip 43 via the wire 15.

The minus terminal 14B is connected to one end of the wire 16. The minus terminal 14B is electrically connected to the electrode 42 via the wire 16.

The welding electric power source 14 configured as described above has a price on the order of 1/10 to ⅓ of the price of a general conventional plasma electric power source, for example. Therefore, by using such a welding electric power source 14, cost reduction of the welding device 10 can be achieved.

The wire 15 is composed of the first wire 15-1 and a second wire 15-2. The other end of the first wire 15-1 is connected to one end of the first selector switch 18. One end of the second wire 15-2 is arranged in the vicinity of the other end of the first wire 15-1. One end of the second wire 15-2 is connected to the first selector switch 18. When the first selector switch 18 is connected to one end of the second wire 15-2, the first wire 15-1 and the second wire 15-2 are electrically connected.

In a state in which the first selector switch 18 is not connected to one end of the second wire 15-2, the first wire 15-1 and the second wire 15-2 are electrically insulated.

The other end of the second wire 15-2 is connected to the insert chip 43.

The other end of the wire 16 is connected to the electrode 42. The wire 16 connects the minus terminal 14B and the electrode 42.

The wire 17 is a branch wire branched from the first wire 15-1, and the chip of the wire 17 is connected to the workpiece 11.

The first selector switch 18 is provided between the other end of the first wire 15-1 and one end of the second wire 15-2. One end of the first selector switch 18 is connected to the other end of the first wire 15-1.

By opening the other end of the first selector switch 18 to the one end of the second wire 15-2, the first wire 15-1 and the second wire 15-2 are electrically insulated (hereinafter, this state is referred to as “OFF state”).

In the pilot arc generation step, the first selector switch 18 is turned off when a pilot arc is generated. By putting the first selector switch 18 in the OFF state, current flows between the workpiece 11 and the electrode 42.

By closing the other end of the first selector switch 18 to one end of the second wire 15-2, the first wire 15-1 and the second wire 15-2 are electrically connected (hereinafter this state will be referred to as “ON state”).

In the welding step (first welding step), the first selector switch 18 is turned on when a main arc is generated. By putting the first selector switch 18 in the ON state, current flows between the electrode 42 and the insert chip 43.

The first selector switch 18 is electrically connected to a control unit (not shown), and the opening/closing operation is controlled by the control unit.

As the first selector switch 18, for example, an electromagnetic switch or an electromagnetic contactor or the like can be used.

The cooling water circulation unit 19 is connected to a circulation line 21 connected to the cooling water flow passage 51. The cooling water circulation unit 19 supplies cooling water to cool the insert chips 43 into the cooling water flow passage 51 via the circulation line 21, recovers the cooling water with increased temperature because of cooling the insert chip 43, after decreases the temperature of the cooling water with increased temperature again, and then supplies the cooling water into the cooling water flow passage 51.

The first pilot gas supply source 23 supplies a first pilot gas that is easily converted into a plasma state. Examples of the first pilot gas which is easy converted into a plasma state include argon gas, a mixed gas of argon and hydrogen, a mixed gas of argon and helium, and a mixed gas of argon and nitrogen.

The first pilot gas supply source 23 is connected to one end of the first pilot gas supply line 25.

In the pilot arc generation step and the welding step (first welding step), the first pilot gas supply source 23 supplies the first pilot gas to the pilot gas supply passage 45 via the first pilot gas supply line 25.

The other end of the first pilot gas supply line 25 is connected to the pilot gas supply passage 45.

The needle valve 27 is provided in the first pilot gas supply line 25 located at the latter stage of the solenoid valve 29. In this manner, by providing the needle valve 27 in the first pilot gas supply line 25 located at the latter stage of the solenoid valve 29, it possible to prevent the rush flow generated at the beginning of the supply of the first pilot gas.

The flow meter 28 is provided in the first pilot gas supply line 25 positioned in the former stage of the needle valve 27. The flow meter 28 measures the flow rate of the first pilot gas flowing through the first pilot gas supply line 25.

As the flow meter 28, for example, a digital type (hot wire type flow meter) or an analog type (float type flow meter) can be used.

The solenoid valve 29 is provided in a first pilot gas supply line 25 located in the former stage of the flow meter 28. When the solenoid valve 29 is opened, the first pilot gas is supplied to the first pilot gas supply line 25 located on the downstream side of the solenoid valve 29. When the solenoid valve 29 is closed, the supply of the first pilot gas to the first pilot gas supply line 25 located on the downstream side of the solenoid valve 29 is stopped.

The needle valve 27, the flow meter 28, and the solenoid valve 29 described above are electrically connected to a control unit (not shown) and are controlled by the control unit.

The shield gas supply source 32 is connected to one end of the shield gas supply line 34. The shield gas supply source 32 supplies the shield gas to the shield gas supply passage 49 via the shield gas supply line 34.

As the shield gas, for example, an inert gas simple substance such as argon gas or helium gas, a mixed gas of argon gas and hydrogen gas (argon-hydrogen gas), a mixed gas of argon gas and helium gas (argon-helium gas), a mixed gas of argon gas, helium gas, and hydrogen gas, a mixed gas of argon and an oxidizing gas, such as oxygen and carbon dioxide, a mixed gas of nitrogen and an inert gas such as argon and helium, a mixed gas of argon, helium, and nitrogen, or the like can be used.

The other end of the shield gas supply line 34 is connected to the shield gas supply passage 49. The shield gas supply line 34 supplies a shield gas into the shield gas supply passage 49.

The needle valve 36 is provided in a shield gas supply line 25 positioned at the latter stage of the solenoid valve 39. In this manner, by providing the needle valve 36 in the shield gas supply line 25 located in the latter stage of the solenoid valve 39, it is possible to prevent the rush flow generated at the beginning of the supply of the shielding gas.

The flow meter 37 is provided in a shield gas supply line 25 located in former stage of the needle valve 36. The flow meter 37 measures the flow rate of the shielding gas flowing through the shielding gas supply line 25.

The solenoid valve 39 is provided in a shield gas supply line 25 located in the former stage of the flow meter 37. When the solenoid valve 39 is opened, the shield gas is supplied to the shield gas supply line 25 located on the downstream side of the solenoid valve 39. When the solenoid valve 39 is closed, the supply of the shield gas to the shield gas supply line 25 located on the downstream side of the solenoid valve 39 is stopped.

The needle valve 36, the flow meter 37, and the solenoid valve 39 described above are electrically connected to a control unit (not shown) and are controlled by the control unit.

Since the welding device 10 having the above-described structure uses a general-purpose TIG welding electric power source, which is less expensive than a general conventional plasma electric power source (more specifically, a electric power source including a plasma arc electric power source, a pilot arc electric power source, and a high-frequency device), as the welding electric power source 14, initial investment in the welding device 10 can be suppressed.

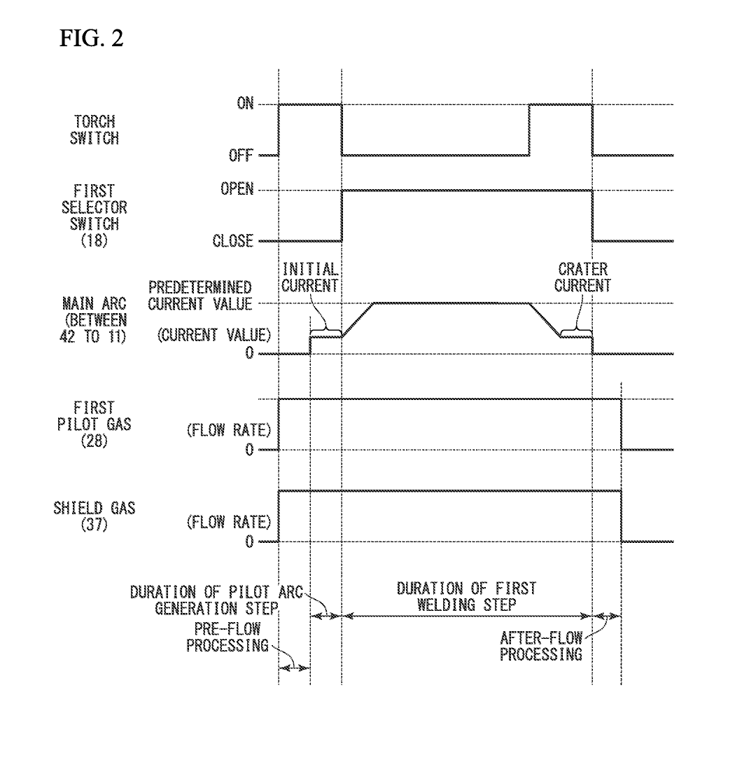

FIG. 2 is a view showing a timing chart for explaining a plasma welding method according to the first embodiment using the welding device shown in FIG. 1.

The numerical values in parentheses shown in the vertical axis of each timing chart of FIG. 2 correspond to the reference numerals of the components of the welding device 10 shown in FIG. 1.

For example, on the vertical axis of the second timing chart from the top in FIG. 2, the “first selector switch (18)” shows the first selector switch 18 shown in FIG. 1.

In addition, on the vertical axis of the third timing chart from the top in FIG. 2, “main arc (between 42 to 11)” means main arc between the electrode 42 and the workpiece 11 shown in FIG. 1.

In this timing chart, the state of occurrence of the main arc generated between the electrode 42 and the workpiece 11 is represented by a change in the value of the current flowing therebetween.

On the vertical axis of the fourth timing chart from the top in FIG. 2, “first pilot gas (28)” indicates the flow rate of the first pilot gas displayed by the flow meter 28 shown in FIG. 1.

Next, with reference to FIG. 1 and FIG. 2, the plasma welding method of the first embodiment will be described by taking the case of using the welding device 10 shown in FIG. 1 as an example.

The plasma welding method of the first embodiment is a welding method in the case of performing welding in which the penetration depth is shallow (for example, 6 mm or less).

The plasma welding method of the first embodiment includes a pilot arc generation step in which a pilot arc is generated between the electrode 42 and the insert chip 43 by electrically connecting the plus terminal 14A and the insert chip 43 by the first selector switch 18, supplying the first pilot gas which is easily converted into a plasma state between the electrode 42 and the insert chip 43 while supplying the shield gas between the insert chip 43 and shield cap 47; and a first welding step in which, after the pilot arc generation step, a main arc is generated between the electrode 42 and the workpiece 11 by electrically disconnecting the plus terminal 14A and the insert chip 43 by the first selector switch 18 and electrically connecting the plus terminal 14A and the workpiece 11 while supplying the pilot gas and the shielding gas.

Hereinafter, the “pilot arc generation step” and the “first welding step” (main arc generation step) included in the plasma welding method of the first embodiment will be described with reference to a timing chart shown in FIG. 2.

The pilot arc generation step is composed of a pre-flow processing period (purge period) and a period which is after the pre-flow processing period, and maintains the current value of the non-transfer type pilot arc at the initial current value.

Together with the start of the pre-flow processing, the torch switch is turned on, the first pilot gas is supplied to the pilot gas supply passage 45, and the shield gas is supplied to the shield gas supply passage 49. In the pre-flow processing, the first selector switch 18 is in the closed state, and a transitional main arc is generated.

As the first pilot gas and shield gas, for example, the above-described gas can be used. Further, the supply amount of the first pilot gas to the pilot gas supply passage 45 can be appropriately set within the range of 0.1 L/min to 10 L/min, for example.

The supply amount of the shielding gas can be appropriately set within a range of 1 L/min to 50 L/min, for example.

Specifically, in the case of using an argon gas as the first pilot gas, and argon gas or a mixed gas obtained by mixing argon gas and 3 to 10% by volume of hydrogen with respect to the volume of the argon gas as the shielding gas, the supply amount of the first pilot gas is, for example, 3 L/min. In this case, the supply amount of the shielding gas is, for example, 20 L/min.

The pre-flow processing time can be, for example, in the range of 0 to 60 seconds. The pre-flow processing is a process for purging the passage of the first pilot gas and the passage of the shielding gas.

In the pilot arc generation step, after the pre-flow processing is completed, the pilot arc is generated between the electrode 42 and the insert chip 43 by maintaining the current value of pilot arc to an initial current (for example, a predetermined current value within the range of 2 to 500 A). In the pilot arc generation step, the same conditions as those of the pre-flow processing are be maintained except that the pilot arc is generated.

At this time, the plus terminal 14A and the workpiece 11 are connected via the wire 17. However, since the distance between the electrode 42 and the workpiece 11 is longer than the distance between the electrode 42 and the insert chip 43, the main arc is not generated between the electrode 42 and the workpiece 11.

At this time, the pilot arc can be easily generated even when the welding electric power source 14 is used by using any one of argon gas, a mixed gas of argon and hydrogen, a mixed gas of argon and helium, and a mixed gas of argon and nitrogen as the first pilot gas.

In addition, in order to improve welding conditions, the first pilot gas may be mixed with at least one of up to about 3% of hydrogen, up to about 10% of helium, or up to about 5% of nitrogen. The purpose of the first pilot gas is to generate a stable pilot arc and a smooth transition to the main arc. Therefore, for this reason, the gas flow rate, the current value for generating the pilot arc, and the ratio of the potential gradient of the pilot gas are appropriately selected.

In the present invention, “gas which is easily converted into a plasma state” means a gas having a small potential gradient ratio (see Table 1). Table 1 shows a rate of potential gradient in various gas atmospheres.

TABLE 1

| Types of gas | Rate of potential gradient |
|---|---|
| Argon | 0.5 |
| Air | 1.0 |
| Nitrogen | 1.1 |
| Carbon dioxide | 1.5 |
| Oxygen | 2.0 |
| Vapor | 4.0 |
| Hydrogen | 10.0 |

In the subsequent first welding step, the supply amount of the first pilot gas and the shielding gas is maintained and the torch switch is turned off, then the predetermined current value of the main arc changes within the current range of the welding device. The current value is gradually increased so that the current value of the main arc becomes a predetermined current value (for example, a predetermined current value within the range of 10 to 300 A, or 2 to 500 A). Then, the predetermined current value is maintained for a certain period, and thereby, a main arc is generated between the electrode 42 and the workpiece 11 to weld the workpiece 11.

Usually, since the no-load voltage of the TIG welding electric power source is smaller than the no-load voltage of the conventional plasma electric power source, it is difficult to shift from the pilot arc to the main arc. However, since the above-mentioned gas which is easily converted into a plasma state is used as the first pilot gas, the transition to the main arc becomes easy.

When the welding of the workpiece 11 is completed, the supply amount of the first pilot gas and the shielding gas is maintained, the torch switch is turned on, the current value of the main arc is gradually increased from the predetermined current value to the crater current value, and thereafter the crater current is maintained for a certain period of time (for example, 0 to 10 seconds).

As the crater current value, for example, a predetermined current value within the range of 2 to 500 A can be used.

After completion of the first welding step, an after-flow processing is performed.

In the after-flow processing, the torch switch is turned off, the current value of the main arc is set to 0 A, and the supply amount of the first pilot gas and the shielding gas is maintained.

The after-flow processing time can be appropriately selected within a range of 0 to 60 seconds, for example.

In this way, oxidation (burning) of the electrode 42 and the weld bead can be prevented by performing the after-flow processing after the first welding step.

After the after-flow processing, the supply of the first pilot gas and the shielding gas is stopped.

According to the plasma welding method of the first embodiment, even when one welding electric power source for a TIG welding device with lower cost and lower no-load voltage is used as the welding electric power source 14, as compared with a general conventional plasma power source, since the electrode and the insert chip are close to each other and a gas such as argon hydrogen gas or argon helium is used in the pilot arc generation step, the pilot arc can be easily generated. In addition, a high-frequency power generator installed in the TIG welding device can also be used.

Further, it is possible to easily shift from the pilot arc to the main arc in the first welding step by using a gas (such as argon) which is easily converted into a plasma state as the pilot gas. Therefore, the initial investment in the welding device 10 can be reduced. In addition, It is also possible to perform plasma welding with penetration depth of about 6 mm.

In the first welding step, the shielding gas may be supplied from the time of starting the welding device 10, or may be supplied at the timing of closing the first selector switch 18 from the startup of the welding device 10.

### Second Embodiment

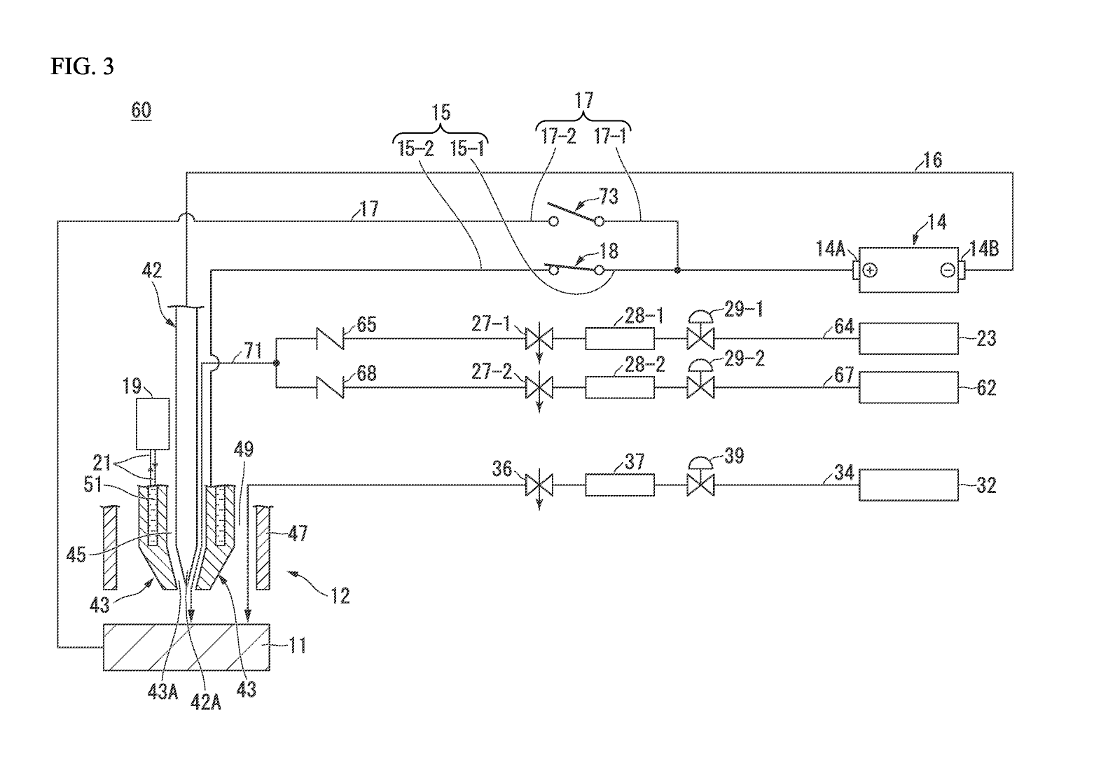

FIG. 3 is a schematic diagram showing a structure of an example of a welding device used for carrying out a plasma welding method according to the second embodiment of the present invention.

In FIG. 3, the same reference numerals are given to the same components as those of the welding device 10 of the first embodiment shown in FIG. 1.

In addition, in FIG. 3, for convenience of explanation, the insert chip 43 and the shield cap 47 which constitute the welding torch 12 and the workpiece 11 are shown in cross section. In addition, FIG. 3 schematically shows a state in which the first selector switch 18 is closed and the second selector switch 73 is opened.

As shown in FIG. 3, the welding device 60 of the second embodiment has the same structure as that of the welding device 10 of the first embodiment, except that, instead of the first pilot gas supply source 23, the first pilot gas supply line 25, the needle valve 27, the flow meter 28, and the solenoid valve 29 of the welding device 10 of the first embodiment, the welding device 60 of the second embodiment includes first and second pilot gas supply sources 23 and 62, first and second pilot gas supply lines 64 and 67, first and second needle valves 27-1 and 27-2, first and second flow meters 28-1 and 28-2, first and second solenoid valves 29-1 and 29-2, first and second check valves 65 and 68, and a pilot gas supply line 71; and further includes a wire 17 having first and second wires 17-1 and 17-2, and a second selector switch 73.

The first and second needle valves 27-1 and 27-2 have the same structure as the needle valve 27 described in the first embodiment. The first needle valve 27-1 is provided in the first pilot gas supply line 64. The second needle valve 27-2 is provided in the second pilot gas supply line 67.

The first and second flow meters 28-1 and 28-2 have the same structure as the flow meter 28 described in the first embodiment. The first flow meter 28-1 is provided in the first pilot gas supply line 64 located between the first pilot gas supply source 23 and the first needle valve 27-1.

The second flow meter 28-2 is provided in the second pilot gas supply line 67 located between the second pilot gas supply source 62 and the second needle valve 27-2.

The first and second solenoid valves 29-1 and 29-2 have the same structure as the solenoid valve 29 described in the first embodiment.

The first solenoid valve 29-1 is provided in the first pilot gas supply line 64 located between the first pilot gas supply source 23 and the first flow meter 28-1. The second solenoid valve 29-2 is provided in the second pilot gas supply line 67 located between the second pilot gas supply source 62 and the second flow meter 28-2.

The second pilot gas supply source 62 supplies a second pilot gas which is more suitable for plasma welding more than the first pilot gas supplied by the first pilot gas supply source 23. As the second pilot gas, for example, argon-hydrogen gas, argon-helium gas or the like can be used.

Argon-hydrogen gas is a suitable pilot gas when it is necessary to deepen penetration depth. Argon-helium gas is a pilot gas suitable for plasma welding double layer stainless steel.

One end of the first pilot gas supply line 64 is connected to the first pilot gas supply source 23 and the other end thereof is connected to one end of the pilot gas supply line 71.

The first check valve 65 is provided in a first pilot gas supply line 64 located between the first needle valve 27-1 and the other end of the first pilot gas supply line 64. One end of the second pilot gas supply line 67 is connected to the second pilot gas supply source 62, and the other end thereof is connected to the pilot gas supply line 71.

The second check valve 68 is provided in the second pilot gas supply line 67 positioned between the second needle valve 27-2 and the other end of the second pilot gas supply line 67.

One end of the pilot gas supply line 71 is connected to the first and second pilot gas supply lines 64 and 67, and the other end is connected to the pilot gas supply passage 45.

One end of the second selector switch 73 is connected to the front end of the first wire 17-1 branched from the first wire 15, and the other end can be opened or closed with respect to one end of the second wire 17-2.

When the second selector switch 73 is closed and connected to one end of the second wire 17-2, the first wire 17-1 and the second wire 17-2 are electrically connected.

When the second selector switch 73 is opened, the first wire 17-1 and the second wire 17-2 are electrically insulated.

As the second selector switch 73, the same one as the first selector switch 18 can be used.

According to the welding device 60 according to the second embodiment, since the needle valve 27-2 is also provided in the second pilot gas supply line 67 located in the latter stage of the solenoid valve 29-2, it is possible to prevent a rush flow occurred at the beginning of gas supply.

In addition, since the first check valve 65 is provided in the first pilot gas supply line 64 located near one end of the pilot gas supply line 71, and the second check valve 68 is provided in the second pilot gas supply line 67 located near one end of the pilot gas supply line 71, it is possible to prevent the second pilot gas from flowing into the first pilot gas supply line 64 located in the former stage of the first check valve 65, and the first pilot gas from flowing into the second pilot gas supply line 67 located in the former stage of the second check valve 68.

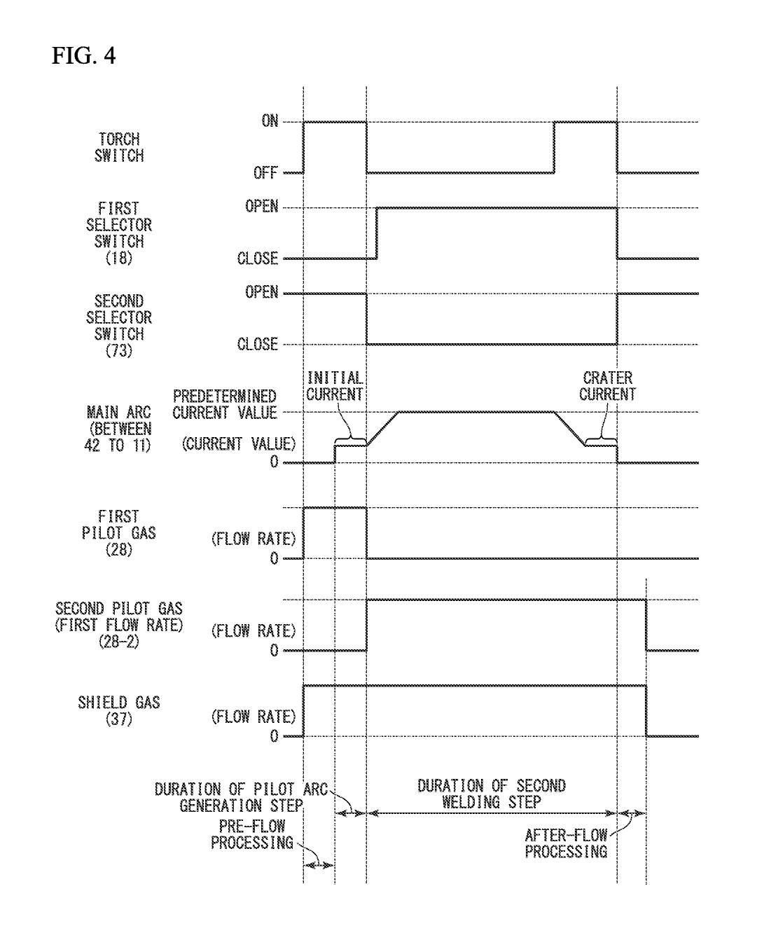

FIG. 4 is a view showing timing chart for explaining a plasma welding method according to the second embodiment using the welding device shown in FIG. 3.

The numerical values in parentheses shown in the vertical axis of each timing chart of FIG. 4 correspond to the reference numerals of the components of the welding device 60 shown in FIG. 3.

Next, with reference to FIG. 3 and FIG. 4, the plasma welding method of the second embodiment will be described by taking the case of using the welding device 60 shown in FIG. 3 as an example.

The plasma welding method of the second embodiment is a welding method in the case of performing welding with a deep penetration depth.

The plasma welding method of the second embodiment includes a pilot arc generation step in which a pilot arc is generated between the electrode 42 and the insert chip 43 by electrically connecting the plus terminal 14A and the insert chip 43 by the first selector switch 18, supplying the first pilot gas which is easily converted into a plasma state between the electrode 42 and the insert chip 43 while supplying the shield gas between the insert chip 43 and shield cap 47; and a second welding step in which, after the pilot arc generation step, a main arc is generated between the electrode 42 and the workpiece 11 by electrically disconnecting the plus terminal 14A and the insert chip 43 by the first selector switch 18, electrically connecting the plus terminal 14A and the workpiece 11 by the second selector switch 73, stopping the supply of the first pilot gas while supplying the shielding gas, and supplying a second pilot gas which is more suitable for plasma welding than the first pilot gas between the electrode 42 and the insert chip 43.

Hereinafter, the “pilot arc generation step” and the “second welding step” included in the plasma welding method of the second embodiment will be described with reference to a timing chart shown in FIG. 4.

In the pilot arc generation step in the plasma welding method of the second embodiment, the same processes as those of the pilot arc generation step described in the first embodiment are performed. In the pilot arc generation step, the second selector switch 73 is in an OPEN state.

As the first pilot gas and shield gas, for example, the same as the first pilot gas and the shield gas described in the first embodiment can be used.

Further, the supply amount of the first pilot gas and the supply amount of the shielding gas can be set to values similar to the supply amount of the first pilot gas and the supply amount of the shielding gas of the first embodiment.

In the subsequent second welding step, the supply of the first pilot gas is stopped, and the torch switch is turned off. While the supply amount of the shielding gas is maintained, the first and second selector switches 18 and 73 are closed. Then, while the second selector switch 73 is closed, the first selector switch 18 is instantaneously opened. Thereby, a second pilot gas (such as argon-hydrogen gas, argon-helium gas, argon-nitrogen gas, or the like), which is more suitable for plasma welding than the first pilot gas is supplied into the pilot gas supply passage 45 at a predetermined flow rate (for example, a predetermined flow rate value in the range of 1 to 10 L/min).

Then, the current value is gradually increased so that the current value of the main arc becomes a predetermined current value (for example, a predetermined current value within the range of 2 to 500 A), and then the predetermined current value is maintained for a certain period. Thereby, a main arc is generated between the electrode 42 and the workpiece 11 to weld the workpiece 11.

As described above, the depth of penetration can be made deeper as compared with the case where the first pilot gas is used in the first welding step in the first embodiment by using the second pilot gas (such as argon-hydrogen gas, argon-helium gas, argon-nitrogen gas, or the like) which is more suitable for plasma welding than the first pilot gas in the second welding step.

Further, in the second welding step, the pilot arc which has been generated in the gap between the electrode 42 and the insert chip 43 can be easily transferred to the main arc by instantaneously opening the first selector switch 18 after the first and second selector switches 18 and 73 are closed.

Next, after the welding of the workpiece 11 is completed, while the supply amount of the second pilot gas and shielding gas is maintained, the torch switch is turned on, and the current value of the main arc is changed from the predetermined current value to the crater current value, and then the crater current is maintained for a certain period of time.

Thereafter, the after-flow processing is performed by the same method as the after-flow processing of the first embodiment.

According to the plasma welding method of the second embodiment, it is possible to perform plasma welding with a deep penetration depth while suppressing the initial investment in the welding device 60.

### Third Embodiment

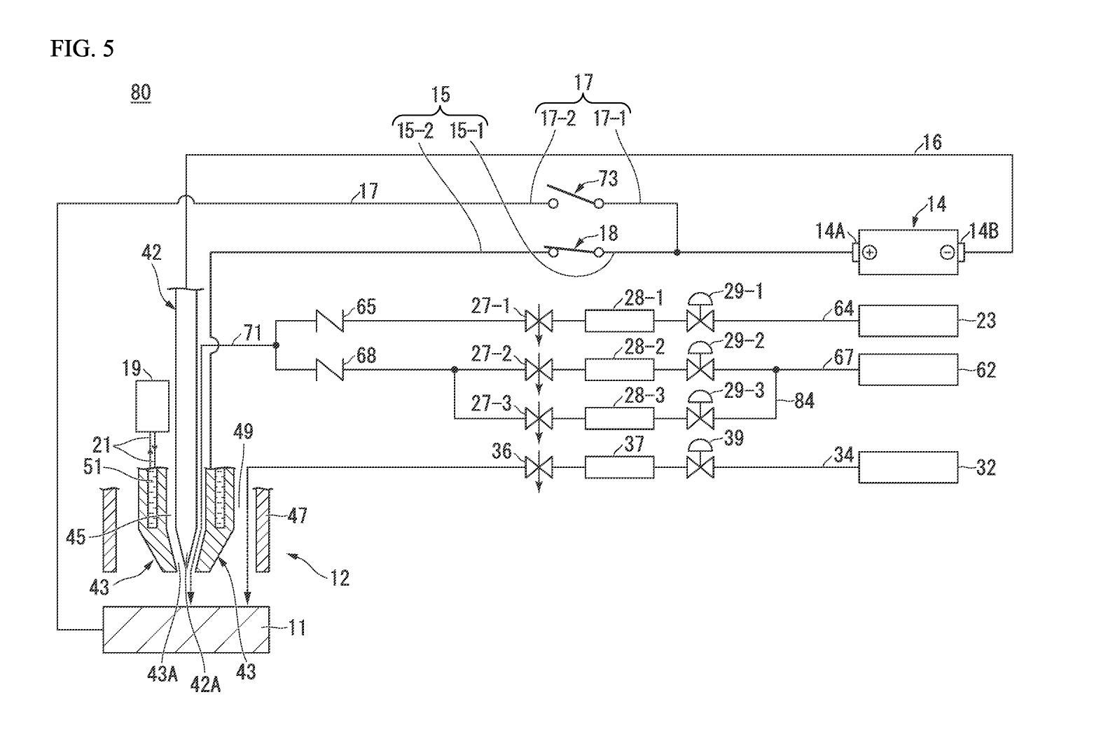

FIG. 5 is a schematic diagram showing a structure of an example of a welding device used in carrying out a plasma welding method according to a third embodiment of the present invention.

In FIG. 5, the same reference numerals are given to the same components as those of the welding device 60 of the second embodiment shown in FIG. 3.

In addition, in FIG. 5, for convenience of explanation, the insert chip 43 and the shield cap 47 which constitute the welding torch 12, and the workpiece 11 are shown in cross section. In addition, FIG. 5 schematically shows a state in which the first selector switch 18 is closed and the second selector switch 73 is opened.

As shown in FIG. 5, the welding device 80 of the third embodiment has the same structure as that of the welding device 60 of the second embodiment, except that further includes a branch line 84, a third needle valve 27-3, a third flow meter 28-3, and a third solenoid valve 29-3.

The branch line 84 is branched from the second pilot gas supply line 67 located between the second solenoid valve 29-2 and the second pilot gas supply source 62, and connected with the second pilot gas supply line 67 located between the second needle valve 27-2 and the second check valve 68.

The third needle valve 27-3 has the same structure as that of the needle valve 27 described in the first embodiment. The third needle valve 27-3 is provided in the branch line 84.

The third flow meter 28-3 has the same structure as that of the flow meter 28 described in the first embodiment. The third flow meter 28-3 is provided in the branch line 84 located between the second pilot gas supply source 62 and the third needle valve 27-3.

The third solenoid valve 29-3 has the same structure as that of the solenoid valve 29 described in the first embodiment. The third solenoid valve 29-3 is provided in the branch line 84 located in the former stage of the third flow meter 28-3.

Since the welding device 80 of the third embodiment includes the branch line 84, the third needle valve 27-3, the third flow meter 28-3, and the third solenoid valve 29-3, it is possible to change the flow rate of the second pilot gas in the third welding step described later.

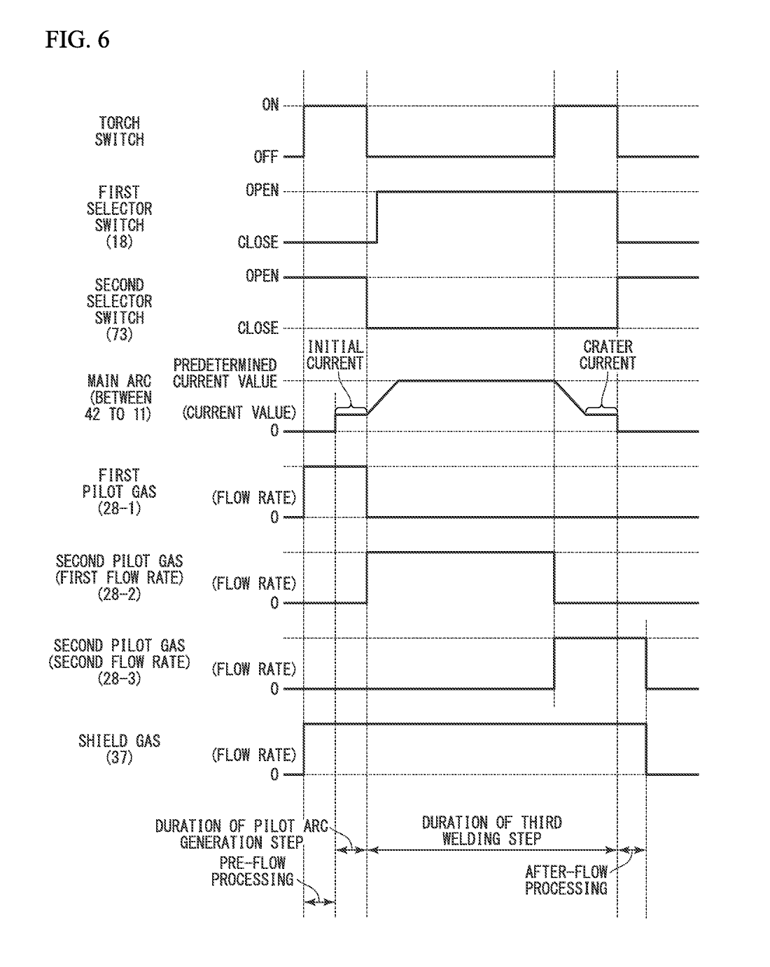

FIG. 6 is a view showing timing chart for explaining a plasma welding method according to the third embodiment using the welding device shown in FIG. 5.

The numerical values in parentheses shown in the vertical axis of each timing chart of FIG. 6 correspond to the reference numerals of the components of the welding device 80 shown in FIG. 5.

Next, with reference to FIG. 5 and FIG. 6, the plasma welding method of the third embodiment will be described by taking the case of using the welding device 80 shown in FIG. 5 as an example.

The plasma welding method of the third embodiment is a welding method in the case of performing welding with a deep penetration depth.

The plasma welding method of the third embodiment includes a pilot arc generation step in which a pilot arc is generated between the electrode 42 and the insert chip 43 by electrically connecting the plus terminal 14A and the insert chip 43 by the first selector switch 18, supplying the first pilot gas which is easily converted into a plasma state between the electrode 42 and the insert chip 43 while supplying the shield gas between the insert chip 43 and shield cap 47; and a third welding step after the pilot arc generation step, wherein the third welding step includes a first stage in which a main arc is generated between the electrode 42 and the workpiece 11 by electrically disconnecting the plus terminal 14A and the insert chip 43 by the first selector switch 18, electrically connecting the plus terminal 14A and the workpiece 11 by closing the second selector switch 73, stopping the supply of the first pilot gas while supplying the shielding gas, and supplying a second pilot gas which is more suitable for plasma welding than the first pilot gas between the electrode 42 and the insert chip 43 at a first flow rate; and a second stage in which while supplying the shield gas, the second pilot gas is supplied at a second flow rate lower than the first flow rate at the end of the third welding step.

Hereinafter, the “pilot arc generation step” and the “third welding step” included in the plasma welding method of the third embodiment will be described with reference to a timing chart shown in FIG. 6.

In the pilot arc generation step in the plasma welding method of the third embodiment, the same processes as those of the pilot arc generation step described in the second embodiment are performed. In the pilot arc generation step, the second selector switch 73 is in an OPEN state.

As the first pilot gas and shield gas, for example, the same as the first pilot gas and the shield gas described in the second embodiment can be used.

Further, the supply amount of the first pilot gas and the shielding gas can be set to the same as the supply amount of the first pilot gas and the shielding gas of the first embodiment.

In the subsequent third welding step, the supply of the first pilot gas is stopped, the torch switch is turned off. While the supply amount of the shielding gas is maintained, the first and second selector switches 18 and 73 are closed. Then, the first selector switch 18 is instantaneously opened while the second selector switch 73 is closed, and the second pilot gas (such as argon-hydrogen gas, argon-helium gas, argon-nitrogen gas, or the like), which is more suitable for plasma welding than the first pilot gas is supplied into the pilot gas supply passage 45 at a first flow rate (for example, a predetermined flow rate value within a range of 0.1 to 10 L/min).

Then, the current value is gradually increased so that the current value of the main arc becomes a predetermined current value (for example, a predetermined current value within the range of 2 to 500 A), and then the predetermined current value is maintained for a certain period. Thereby, the main arc is generated between the electrode 42 and the workpiece 11 to weld the workpiece 11.

Subsequently, at the stage when welding of the workpiece 11 is completed, the supply of the second pilot gas which does not flow through the branch line 84 is stopped, and the second pilot gas is supplied through the branch line 84 at the second flow rate, which is smaller than the first flow rate. The torch switch is turned on, and the current value of the main arc is gradually lowered from the predetermined current value to the crater current value, and then the crater current is maintained for a certain time.

For example, when the first flow rate is 3 L/min, the second flow rate can be set to 1 L/min, for example.

Thereafter, the after-flow processing is performed by the same method as the after-flow processing of the first embodiment.

According to the plasma welding method of the third embodiment, it is possible to weld having a large penetration depth and can penetrate through the workpiece 11, while suppressing initial investment in the welding device 80.

Although the preferred embodiments of the present invention have been described in detail above, the present invention is not limited to such specific embodiments, and various modifications and changes are possible within the scope of the gist of the present invention described in claims.

For example, in the welding device 10 shown in FIG. 1, the second selector switch 73 may be provided in the wire 17. Thereby, the workpiece 11 and the plus terminal 14A of the welding electric power source 14 can be electrically switched to the connected state or the disconnected state by the second selector switch 73.

In the case of using the welding device having such a structure, the pilot arc generation step differs from the pilot arc generation step described in the first embodiment in the following points.

In the welding device having the above-described structure, in the pilot arc generation step, the second selector switch 73 is initially in an OPEN state (a state where the second selector switch 73 is not electrically connected). As the kind and supply amount of the first pilot gas 23 and the shielding gas 32, for example, the same kind and supply amount as the first pilot gas and shielding gas described in the first embodiment can be used.

In the subsequent welding step, the torch switch is turned off, while maintaining the supply amount of the first pilot gas and the shielding gas, the first and second selector switches 18 and 73 are closed (an electrically connected state). Thereafter, the first selector switch 18 is instantaneously opened, and then a predetermined current value is maintained for a certain period, thereby generating the main arc between the electrode 42 and the workpiece 11 to weld the workpiece 11.

According to the welding device having the above-described structure and the plasma welding method, it is possible to restrain the rush flow, and stably generate the main arc without discontinuing the arc. As a result, stable welding is possible even in the initial stage of the welding step.

Next, a modified example of the welding device 80 shown in FIG. 5 will be described.

In the welding device of this modification embodiment, instead of the second selector switch 73, a wire which is always electrically connected between the plus terminal 14A of the welding electric power source 14 and the workpiece 11, may be provided.

The plasma welding method in this case includes the following pilot arc generation step and welding step.

In the pilot arc generation step, the plus terminal 14A and the insert chip 43 are electrically connected by the first switch 18, the first pilot gas which is easily converted into a plasma state is supplied between the electrode 42 and the insert chip 43, the shield gas is supplied between the insert chip 43 and the shield cap 47, and thereby the pilot arc is generated between the electrode 42 and the insert chip 43.

Next, in the welding step, after the pilot arc generation step, the plus terminal 14A and the insert chip 43 are electrically disconnected by the first selector switch 18, while the supply of the first pilot gas and the shielding gas is continued, the workpiece 11 is welded by generating the main arc between the electrically connected electrode 42 and workpiece 11.

Thereafter, when welding of the workpiece 11 is completed, the second pilot gas of a predetermined flow rate is supplied via the branch line 84, the torch switch is turn on, the current value of the main arc is gradually decreased from a predetermined current value to the crater current value, and thereafter the crater current is maintained for a certain time. For example, the predetermined flow rate can be, for example, 1 L/min.

Thereafter, the after-flow processing is performed by the same method as the after-flow processing of the third embodiment.

In other words, at the beginning of the welding step, switching from the first pilot gas 23 to the second pilot gas 62 is not performed. However, at the end of the welding step, while supplying the shielding gas, the second pilot gas is supplied at a predetermined flow rate from the branch line 84.

According to the welding device having the above-described structure and the plasma welding method, it is possible to prevent the rush flow, the generation of depressions in the crater section of the welded portion, and the occurrence of pores in the welded portion.

Next, another modification of the welding device 80 shown in FIG. 5 will be described.

In this case, at the beginning of the welding step, switching from the first pilot gas 23 to the second pilot gas 62 is not performed. However, at the end of the welding step, while supplying the shielding gas, the second pilot gas is supplied at a predetermined flow rate through the branch line 84.

According to the welding device having the above-described structure and the plasma welding method, it is possible to prevent the rush flow, the generation of depressions in the crater section of the welded portion, and the occurrence of pores in the welded portion.

Similar to the first to third embodiments, any one of argon gas, a mixed gas of argon and hydrogen, a mixed gas of argon and helium, a mixed gas of argon and nitrogen (argon-nitrogen gas) can be used as the first pilot gas in the above three modifications.

In the case of using the second pilot gas, a gas which has a higher potential gradient ratio than that of the first pilot gas, and is selected from a mixed gas of argon and hydrogen, a mixed gas of argon and helium, a mixed gas of argon and nitrogen, a mixed gas of argon, helium and hydrogen, and a mixed gas of argon, helium, and nitrogen can be used as the second pilot gas.

In the above three modifications, a no-load voltage or a high-frequency voltage generating device of the TIG welding electric power source can be used as the power source used for generating the main arc.

The welding device of the three modifications may include a shield gas supply line which is connected to a shield gas supply source and supplies the shield gas to the welding torch, a pilot gas supply line which is connected to the pilot gas supply source and supplies the pilot gas to the welding torch, and a solenoid valve and a check valve may be provided in the shielding gas supply line and/or the pilot gas supply line in this order in a direction from the upstream side to the downstream side.

As described above, according to the present invention, the number of switches used in the main arc generation step, the presence or absence of switching between the first pilot gas and the second pilot gas, the type and the flow rate of the pilot gas, and the presence or absence of the after-flow processing at the end of the welding step can be combined depending on the workpiece to be welded and the welding purpose.

Moreover, in the pilot arc generation step, the main arc generation step, and the step in which the crater current value is maintained for a certain period of time, the flow rate of the first pilot gas may be appropriately varied to not be the same.

### INDUSTRIAL APPLICABILITY

The present invention can be applied to a plasma welding method capable of performing plasma welding while suppressing initial investment in a welding device.

### EXPLANATION OF REFERENCE NUMERAL

10, 60, and 80 welding device
11 workpiece
12 welding torch
14 welding electric power source
14A plus terminal
14B minus terminal
15 to 17 wire
15-1 and 17-1 first wire
15-2 and 17-2 second wire
18 first selector switch
19 cooling water circulation section
21 circulation line
23 first pilot gas supply source
25 and 64 first pilot gas supply line
27 and 36 needle valve
27-1 first needle valve
27-2 second needle valve
27-3 third needle valve
28 and 37 flow meter
28-1 first flow meter
28-2 second flow meter
28-3 third flow meter
29 and 39 solenoid valve
29-1 first solenoid valve
29-2 second solenoid valve
29-3 third solenoid valve
32 shield gas supply source
34 shield gas supply line
42 electrode
42A distal end
43 insert chip
43A insert chip hole
45 pilot gas supply passage
47 shield cap
49 shield gas supply passage
51 cooling water passage
62 second pilot gas supply source
65 first check valve
67 second pilot gas supply line
68 second check valve
71 pilot gas supply line
73 second selector switch
84 branch line

1. A plasma welding method using a welding device comprising one welding electric power source for a TIG welding device; a welding torch comprising an electrode extending in a predetermined direction, an insert tip surrounding the electrode, and a shield cap surrounding the outside of the insert tip; and a first selector switch which is configured to electrically connect or disconnect a plus terminal of the welding electric power source and the insert chip,
wherein the plasma welding method comprises:
a pilot arc generation step in which a pilot arc is generated between the electrode and the insert chip by electrically connecting the plus terminal and the insert chip by the first selector switch, supplying a first pilot gas which is easily converted into a plasma state between the electrode and the insert chip while supplying a shield gas between the insert chip and the shield cap; and
a first welding step in which, after the pilot arc generation step, a main arc is generated to weld the workpiece between the electrode and the workpiece by electrically disconnecting the plus terminal and the insert chip by the first selector switch while supplying the first pilot gas and the shield gas.

2. The plasma welding method according to claim 1, wherein the plasma welding method comprises a second welding step, instead of the first welding step; and
in the second welding step, after the pilot arc generation step, the main arc is generated to weld the workpiece between the electrode and the workpiece by electrically disconnecting between the plus terminal and the insert chip by the first selector switch, then electrically connecting the plus terminal and the workpiece, stopping the supply of the first pilot gas, while supplying the shield gas, and supplying a second pilot gas which is more suitable for plasma welding than the first pilot gas between the electrode and the insert chip.

3. The plasma welding method according to claim 2,
wherein the plasma welding device further comprises a second selector switch which is configured to electrically connect or disconnect between the plus terminal and the workpiece, and
in the second welding step, while the plus terminal and the insert chip are electrically connected with each other by the first selector switch, the plus terminal and the workpiece are electrically connected with each other by the second selector switch, and then the plus terminal and the insert chip are instantaneously electrically disconnected by the first selector switch.

4. The plasma welding method according to claim 1,
wherein the welding device further comprises a wire which is configured to always electrically connect between the plus terminal and the workpiece, and
the plasma welding method comprises a third welding step instead of the first welding step, and
the third welding step comprises:
a first stage in which, after the pilot arc generation step, the main arc is generated between the electrode and the workpiece by electrically disconnecting the plus terminal and the insert chip by the first selector switch, stopping the supply of the first pilot gas while supplying the shield gas, and supplying a second pilot gas which is more suitable for plasma welding than the first pilot gas between the electrode and the insert chip at a first flow rate; and
a second stage in which while supplying the shield gas, the second pilot gas is supplied at a second flow rate lower than the first flow rate at the end of the third welding step.

5. The plasma welding method according to claim 4,
wherein the plasma welding device comprises another wire in which a second selector switch configured to electrically connect or disconnect between the plus terminal and the workpiece is provided, instead of the wire, and
in the third welding step, while the plus terminal and the insert chip are electrically connected with each other by the first selector switch, the plus terminal and the workpiece are electrically connected with each other by the second selector switch, and then the plus terminal and the insert chip are instantaneously electrically disconnected by the first selector switch.

6. The plasma welding method according to claim 1, wherein any one selected from the group consisting of argon gas, a mixed gas of argon and hydrogen, a mixed gas of argon and helium, and a mixed gas of argon and nitrogen is used as the first pilot gas.

7. The plasma welding method according to claim 2, wherein a gas which has a higher potential gradient ratio than that of the first pilot gas, and is selected from a mixed gas of argon and hydrogen, a mixed gas of argon and helium, a mixed gas of argon and nitrogen, a mixed gas of argon, helium and hydrogen, and a mixed gas of argon, helium, and nitrogen is used as the second pilot gas.

8. The plasma welding method according to claim 1, wherein a no-load voltage of a TIG welding electric power source is used to generate the main arc.

9. The plasma welding method according to claim 1, wherein a high-frequency voltage generating device of a TIG welding electric power source is used to generate the main arc.

10. The plasma welding method according to claim 1, wherein the welding device further comprises a shield gas supply line which is connected to a shield gas supply source and supplies the shield gas to the welding torch, a pilot gas supply line which is connected to a pilot gas supply source and supplies the pilot gas to the welding torch, and a solenoid valve and a check valve are provided in the shielding gas supply line and/or the pilot gas supply line in this order in a direction from the upstream side to the downstream side.
